(19) United States
(12) Patent Application Publication
(10) Pub. No.: US 2021/0246581 A1
(43) Pub. Date: Aug. 12, 2021

(54) RETRIEVING AND REPOLYMERIZING TEXTILE FIBERS

(71) Applicant: EVRNU, SPC, Seattle, WA (US)

(72) Inventors: Stacy Flynn, Seattle, WA (US); Christopher Stanev, Rutherford, NJ (US)

(21) Appl. No.: 17/167,986

(22) Filed: Feb. 4, 2021

Related U.S. Application Data
(60) Provisional application No. 62/970,879, filed on Feb. 6, 2020.
(60) Provisional application No. 63/036,875, filed on Jun. 9, 2020.

(51) Int. Cl. D01G 11/00; D01F 2/02; D01G 5/00; D01F 13/02

(52) U.S. Cl. CPC D01G 11/00; D01F 13/02; D01G 5/00; D01F 2/02

(57) ABSTRACT

The present disclosure relates to methods and systems for recovering and repolymerizing textile fibers. Textile fibers, such as those containing cellulose or elastomers, can undergo multiple rounds of recovery and regeneration. During the regeneration process, the textile fibers are isolated from non-desired material, repolymerized or reformed, and then extruded to form a second set of textile fibers. The degree of polymerization of the textile fiber decreases with each regeneration cycle. Regeneration and production can be repeated any appropriate number of times until the regenerated textile fibers do not have the necessary or appropriate degree of polymerization for textile production.

### CROSS-REFERENCE TO RELATED APPLICATIONS

This application claims the benefit of pending U.S. Provisional Patent Application No. 62/970,879, filed Feb. 6, 2020, and pending U.S. Provisional Patent Application No. 63/036,875, filed Jun. 9, 2020. The contents of which are herein incorporated by reference in their entirety.

### BACKGROUND

Global sales of apparel are estimated to have exceeded $1 trillion in 2011, and some estimate that over 85% of the garments purchased are discarded in a landfill within one year. This cycle wastes valuable materials and the considerable resources required to produce them, and it exacerbates waste disposal issues.

Cotton clothing is estimated to represent about 35% of the total apparel market. Cotton fibers are composed of cellulose, a naturally occurring polymer found in all plants, wood, and natural fibers. Cotton fibers are harvested from cotton plants and consist of long, interwoven chains of cellulose polymers. These fibers are spun into thread or yarn, dyed, and ultimately woven, knit, and assembled into textiles. Natural fibers, including cotton, have a generally high and variable raw material cost due, in part, to natural disasters and climate unpredictability, regional socio-economic and political instability, human rights issues, and resource requirements.

Growing and harvesting cotton fibers is resource-intensive. It is estimated, for example, that over 700 gallons of water are required to grow enough cotton to produce one pound of fiber. Growing cotton frequently involves heavy pesticide use, significant land resources, and produces significant levels of heat-trapping gases. Considerably more land is required for growing organic cotton than for growing “conventional” cotton. With demand for agricultural land use increasing and fresh water supplies decreasing, the cost of producing natural cotton is increasing. At some point, the current scale of cotton production may become unprofitable and unsustainable.

Cotton has been recycled to provide raw material for paper pulping plants. Re-processing methods that convert used cotton into rags, mattress ticking, seat stuffing, insulating materials, and the like are also available, but these processing methods have been adopted in limited applications because the value of the converted material is relatively low.

In contrast to cotton, which is a natural fiber, rayon fibers are manufactured from wood pulp using the viscose process. In this process, purified cellulose is solubilized and then converted or regenerated into cellulose fiber. This process requires steeping, pressing, shredding, aging, xanthation, dissolving, ripening, filtering, degassing, spinning, drawing and washing. This process is time sensitive, requires multiple chemical treatments, produces lignin and other waste from unusable wood material and is, at best, a semi-continuous manufacturing process.

The present disclosure is directed to providing systems and methods for processing cellulose-containing feedstocks, such as recycled fabric, fabric scraps and other cellulose containing materials, many of which would otherwise be wasted or used to produce low value products, to isolate their constituent cellulosic polymeric structures. The polymeric cellulosic structures are then used in industrial processes such as fabric production. Implementation of the disclosed processing schemes with a variety of garment/fabric feedstock materials may produce regenerated fibers and textile products having improved, customizable, or both properties using processes having low environmental impacts.

### SUMMARY

Methods and systems of the present disclosure relate to processing of cellulose-containing materials including, for example, postconsumer cellulosic waste, cellulose-containing textiles and garments (e.g., recycled or used or waste textiles and garments), virgin cotton, wood pulp, biomass, and the like, to produce isolated cellulose polymers for use in downstream processing applications. In some embodiments, cellulose-containing materials used as raw feed material for processing comprise discarded garments, scrap fabric materials, or both, and processing produces isolated cellulose polymers that can be further processed and extruded to provide regenerated fibers having improved, customizable, or both properties for use in textile industries or for other purposes.

A multi-stage process is described, incorporating one or more pretreatment stages providing removal of contaminants and preparation of cellulosic materials, followed by pulping, molecular separation of cellulose polymers, or both. In some embodiments, the pretreatment and pulping processes may be carried out in a continuous, semi-continuous or batch system. In some embodiments, the pretreatment and pulping processes may be carried out in one or more closed reaction vessel(s), and processing reagents may be recovered and re-used or processed for other uses.

Numerous pretreatment processing stages are described and may be used alone or in combination to remove non-cellulosic constituents of the feed and prepare cellulosic components for pulping and dissolution. Pretreatment is followed by at least one cellulose pulping or dissolution stage that promotes the molecular separation and isolation of cellulose polymers, such as by disrupting intermolecular hydrogen bonds. In some embodiments, cellulosic polymers isolated during the pulping stage, the dissolution stage, or both, are substantially thermoplastic and are moldable when energy (e.g., heat below the char point) is introduced to the system.

Isolated cellulose polymers produced using the processes described herein may be used in a variety of downstream applications, as described in more detail below and, in some embodiments, may be extruded to form regenerated cellulosic fibers. In some aspects, isolated cellulose polymers may be re-generated to provide longer chain polymers and fibers (or polymers and fibers having other desirable characteristics different from the characteristics of the cellulose-containing feedstock) that are useful in various industrial processes, including textile production. In addition to employing a raw feedstock materials that are typically discarded (wasted, at a cost), processing steps having generally low environmental impacts are preferred.

In one aspect, methods and systems of the present disclosure provide a closed-loop garment recycling process that transforms reclaimed garments and textiles into high-quality, bio-based fiber for use in creating new textiles, apparel, and other fiber-based products. Used and waste garment collection, sorting, transport and processing may all be involved as part of a closed loop process. Retail enterprises (and others) may serve as collection stations and may offer incentives, rewards, or the like for donations. Further garment processing may take place at the donation site or at one or more remote sites. Cotton, cotton-like regenerated fabrics, rayon and other fibers may be produced using the reclaimed garments and textiles.

### BRIEF DESCRIPTION OF THE DRAWINGS

FIG. 1 illustrates an exemplary schematic flow diagram outlining process steps as disclosed herein for converting cellulose-containing materials to liquefied cellulose suitable for use in a variety of downstream applications.

FIG. 2 illustrates an exemplary schematic flow diagram outlining process steps as disclosed herein for converting cellulose-containing materials to regenerated cellulosic fiber and incorporating one or more of a variety of pretreatments.

FIG. 3 illustrates an exemplary schematic flow diagram outlining process steps as disclosed herein for converting cellulose-containing materials to regenerated cellulosic fiber incorporating a high temperature aqueous or supercritical carbon dioxide pretreatment step and incorporating optional additional treatment steps.

FIG. 4 illustrates an exemplary schematic flow diagram outlining process steps as disclosed herein for converting cellulose-containing materials to regenerated cellulosic fiber incorporating a combination of pretreatment steps.

FIG. 5 illustrates an exemplary schematic flow diagram outlining process steps as disclosed herein for converting cellulose-containing materials to regenerated cellulosic fiber incorporating another combination of pretreatment steps.

FIG. 6 illustrates an exemplary schematic flow diagram outlining process steps as disclosed herein for converting cellulose-containing materials to regenerated cellulosic fiber incorporating another combination of pretreatment steps.

FIG. 7 illustrates an exemplary schematic flow diagram outlining process steps as disclosed herein for converting cellulose-containing materials to regenerated cellulosic fiber incorporating yet another combination of pretreatment steps.

FIG. 8 illustrates an exemplary schematic flow diagram outlining process steps as disclosed herein for processing blended textile input to produce liquefied cellulosic and polymeric output.

FIG. 9A shows a magnified image of a regenerated cellulosic fiber produced as described herein. FIG. 9B shows a magnified image of a premium long-staple cotton fiber as tested in Harzallah, Benzina & Drean, 2009. FIG. 9C shows an enlarged, cross-sectional view of a regenerated cellulosic fiber produced as described herein.

FIG. 10 illustrates an exemplary schematic flow diagram for developing and retrieving a recoverable elastomer to produce a first article of manufacture and then a second article of manufacture.

FIG. 11 illustrates an exemplary schematic flow for performing multiple rounds of cellulosic material regeneration.

It will be understood that the appended drawings present many alternatives and various specific embodiments, and that there are many variations and combinations of processing steps, as well as additional aspects of systems and methods of the present invention. Specific process design features may be modified and used in different combinations, for example, for use in various intended applications and environments.

### DETAILED DESCRIPTION

In one aspect, systems and methods disclosed herein process cellulose-containing materials to produce isolated cellulosic polymers suitable for use in downstream processing and a variety of downstream applications and production pathways. Cellulose-containing materials that are useful as raw materials for this process include a wide range of materials, such as cellulose-containing postconsumer waste, biomass materials and pulp (e.g., wood pulp), cotton and cotton-containing materials, and the like, including unworn or worn and discarded cotton and cotton-containing apparel, as well as scrap cotton fiber and fabric. The cellulose-containing feedstock undergoes at least one pretreatment stage (and optionally multiple pretreatment stages) and at least one pulping or dissolution stage to produce isolated cellulose molecules suitable for use in various different application pathways.

The raw cellulose-containing feed material may be substantially homogeneous (e.g., pre- or post-consumer waste, scrap textile fiber and fabric, cotton-containing fabrics, biomass or pulped wood or biomass, etc.), or it may be at least somewhat heterogeneous (e.g., cellulose-containing materials from mixed sources and of mixed types). When post-consumer textile materials are used as feedstock, used clothing collection and sorting may be accomplished via clothing retailers, manufacturers, recyclers, and various other organizations, providing access to large volumes of used, cellulose-containing garments and scrap materials that would otherwise be discarded. Depending on the type and homogeneity of the cellulose-containing feedstock, optional sorting and removal of non-cellulosic components may be carried out prior to pretreatment of the cellulose-containing feedstock.

When reclaimed garments and textiles are used as cellulose-containing feed material, initial sorting of reclaimed garments and textiles according to fiber content may be advantageous prior to feedstock pretreatment and dissolving. In some embodiments, for example, reclaimed material (e.g., garments and textiles) may be sorted by cellulosic content—e.g., reclaimed materials may be separated into groups having different cellulosic contents, such as >90% or >80% or >70% or >50%, or other cellulosic contents, and less than 50% cellulosic content. Reclaimed fabric material having other fiber contents and compositions may also be sorted and separated, and reclaimed material may also be sorted by composition, such as separating cotton-wool blends, cotton-polyester blends, cotton-elastane blends, cotton-spandex blends, and the like. Separation of non-cellulosic-containing materials such as buttons, zippers, and the like may take place at the time of or following sorting and process pretreatment. Likewise, mechanical sizing or comminution, such as shredding, pulling, grinding, cutting, tearing, and the like may take place prior to or following sorting and process pretreatment.

Cellulosic feedstocks such as reclaimed garments and textiles typically incorporate a variety of dyes, chemical finishes, or both, and may be contaminated with other materials, such as dirt, grease, and the like. Other types of cellulosic feedstocks, such as biomass, postconsumer waste, and the like, also contain contaminants that are desirably removed prior to a pulping stage. Raw cellulose-containing feedstock (optionally treated to remove non-cellulose-containing materials, and optionally sized) is typically processed in one or more pre-treatment stage(s) to remove dyes, finishes, contaminants (oils, grease, etc.) and the like from the feedstock. Cellulosic feedstocks including textile materials may optionally be mechanically treated to provide smaller sized, or more uniformly sized, feedstock. The fabric feedstock may be sized if desired, such as by shredding, to provide a sized feedstock having a fragmented, high surface area for fiber pulping. Feedstock sizing is typically accomplished using mechanical cutting, shredding, or other mechanical size reduction techniques. Processing to remove non-cellulosic components, such as buttons, zippers, fasteners, and the like may take place, if desired, prior to pretreatment, following pretreatment, or both.

Several different pre-treatment stages are described below, and various combinations of pretreatment stages may provide benefit, depending on the nature of the cellulosic feedstock. Depending on the properties of the raw textile feedstock, one or more of the pretreatments may be used, alone or in combination with other pretreatments. Several (optional) pre-treatment stages are described below, and several advantageous pre-treatment combinations are also described. It will be appreciated that additional pre-treatments may be used in combination with the pre-treatments described, and that various specific combinations other than those specifically illustrated and described may be used.

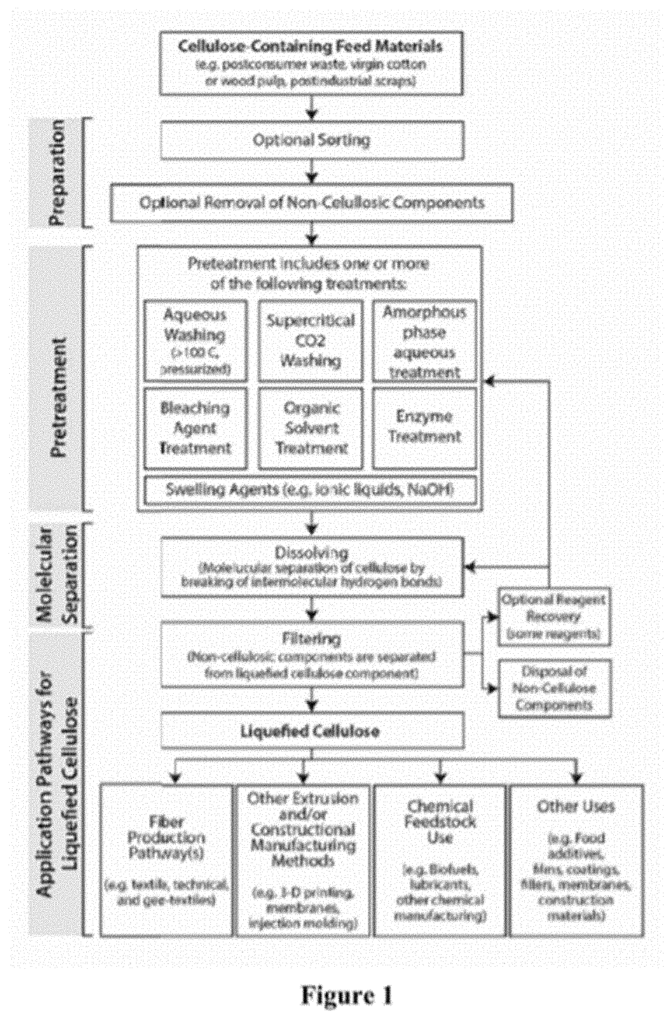

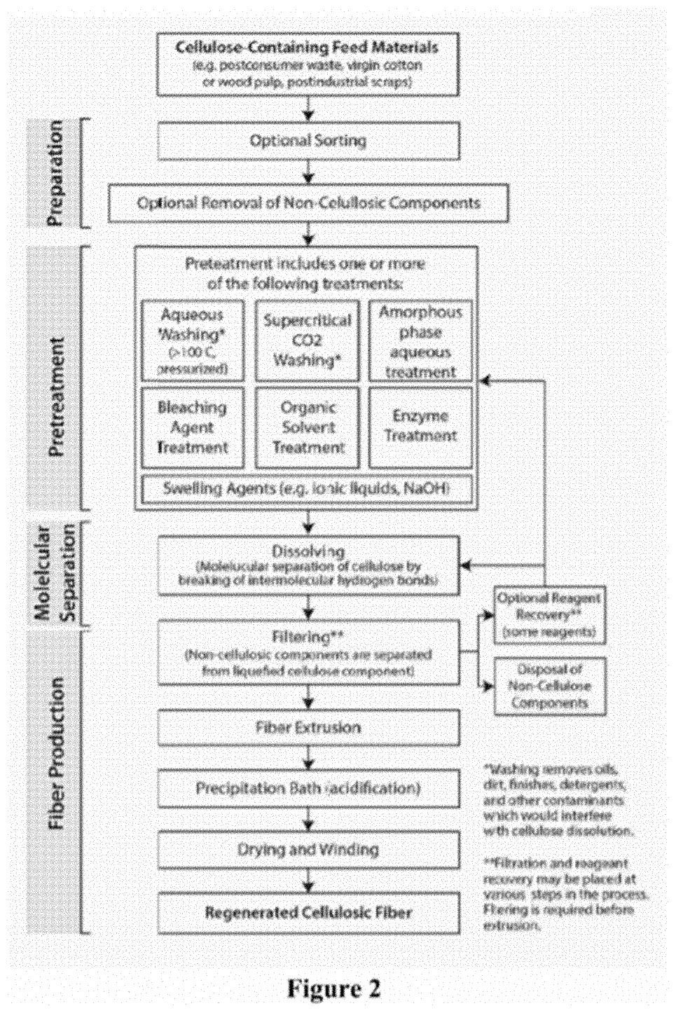

FIG. 1 illustrates an overall process flow diagram for treating cellulose-containing materials to produce isolated cellulose polymers, identified in FIG. 1 as “Liquefied Cellulose,” suitable for use in a variety of downstream applications, such as fiber production (e.g., textiles, technical fibers and geo-textiles), production of other extrusion manufacturing methods, constructional manufacturing methods (e.g., 3D printing media, membranes, injection molding media), or both, use as a chemical feedstock for production of biofuels, lubricants and other chemical manufacturing, and for use as food additives, in films, coating, fillers, membranes, packaging, construction materials, non-woven materials, and the like. FIG. 2 illustrates an overall process flow diagram for treating cellulose-containing materials to produce liquefied cellulose suitable for fiber extrusion and including additional processing stages for production of regenerated cellulosic fiber. The cellulose-containing materials may undergo similar pretreatment and the pulping stage, the dissolution stage, or both, as illustrated in FIGS. 1 and 2, while the isolated cellulose product may be used for different applications, as shown.

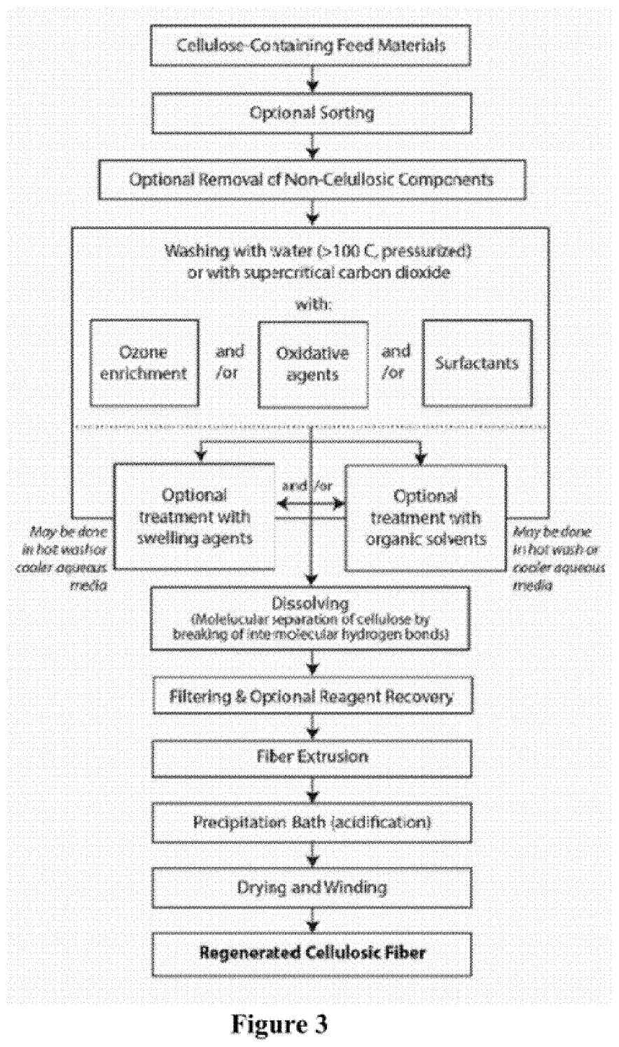

In general, cellulose-containing feed materials may undergo optional feedstock preparation stages, such as feedstock sorting, removal of non-cellulosic components, or both. The cellulose-containing feedstock then undergoes at least one pretreatment stage, followed by pulping or, dissolution of, or both, the pretreated cellulose-containing feedstock and filtration to produce isolated cellulose polymers. Several pretreatment stages are described below and are illustrated in the accompanying diagrams. Depending on the composition of the cellulose-containing feedstock and the attributes of the cellulosic product desired, one or more than one of the pretreatment stages may be used alone or in combination with other pretreatment stages. Specific combinations of pretreatments that may be useful in particular applications are described in greater detail below with reference to FIGS. 3-7. Each of the pretreatment stages is described in more detail below.

### High Temperature Aqueous Washing

In one embodiment, methods disclosed herein provide pretreatment of cellulose-containing feed materials using a high temperature aqueous washing process. This pretreatment stage is particularly useful for pretreatment of cellulose-containing feed materials comprising recycled garments and may facilitate removal of contaminants such as soils, deodorants, lanolin, silicone and cationic softeners from the feedstock, as well as stripping various fabric treatments, such as optical brighteners, moisture wicking enhancers, and the like, from the feed material. Aqueous media maintained at a temperature above 100° C., optionally above the boiling point of the aqueous media, generally above 120° C., often between 120° C. and 170° C., sometimes between 130° C. and 150° C., and up to 200° C., may be used. In some embodiments, the high temperature aqueous washing pretreatment stage is conducted in a closed vessel batch system with circulation or agitation or mixing of the hot aqueous media. Pressure conditions in a closed vessel system, as described, may range from about 100 kPa to about 2000 kPa, depending on the temperature of the aqueous media, with higher pressure conditions accompanying higher temperature media.

Aqueous media used in a high temperature pretreatment stage may comprise water alone, or it may comprise an aqueous solution having one or more additives. In some embodiments, the aqueous media may comprise water enriched with ozone. In some embodiments, the aqueous media may comprise water enriched with oxidative agents such as hydrogen peroxide or sodium perborate. In additional embodiments, surfactants (e.g., Sodium stearate, Fatty Alcohols, 4-(5-Dodecyl) benzenesulfonate, Alcohol ethoxylates and the like), various hydroxide compositions (e.g., Ca, Mg, Na, K, and Li hydroxides), the like, or combinations or multiples thereof, may be mixed and circulated with the aqueous media in a high temperature aqueous pretreatment stage and may act as wetting agents. In some embodiments, the high temperature aqueous washing stage incorporates an aqueous solution comprising NaOH at a concentration of from about 1% to about 15%, at a pH in excess of about 11, and in some embodiments in excess of about 12. Residence times are sufficient to substantially remove impurities from the cellulose-containing feedstock.

The aqueous wash solution may be evacuated following a suitable residence time. In some embodiments, multiple aqueous washing stages may be implemented, using the same or different aqueous solutions, all at high temperature and pressure conditions. Optional rinsing of the solids with an aqueous solution may be implemented following evacuation of the wash solution. Rinsing may take place at ambient temperatures and pressures, with optional agitation and mixing, and the rinse solution is removed following a suitable residence time. Cellulose-containing treated solids may undergo one or more additional pretreatment stage(s) or may be further processed in a pulping stage, a dissolution stage, or both.

### Supercritical CO₂ Washing

In some embodiments, a water-less pretreatment, “non-toxic” pretreatment, or both, may be used to remove contaminants such as dyes, finishes, surface impurities and other contaminants from cellulose-containing feed materials, and particularly from feed materials comprising recycled garments or textiles. In this treatment stage, cellulose-containing feed material may be introduced to a closed and pressurized chamber, where the feed material contacts supercritical carbon dioxide, alone or in combination with additional reagent(s). In some embodiments, the supercritical CO₂ may be enriched with ozone. In some embodiments, the supercritical CO₂ may enriched with oxidative agents such as hydrogen peroxide or sodium perborate. In additional embodiments, surfactants (e.g., Sodium stearate, Fatty Alcohols 4-(5-Dodecyl) benzenesulfonate, Alcohol ethoxylates and the like) may be mixed and circulated with the supercritical CO₂ in a pretreatment stage. Following a suitable residence time, supercritical carbon dioxide containing dissolved contaminants is withdrawn to a separator, where the carbon dioxide may be decompressed and returned to a gaseous state, while the contaminants may be collected and removed. The gaseous carbon dioxide may be recycled in a closed loop process and re-used for additional pretreatment cycles. Cellulose-containing treated solids may undergo one or more additional pretreatment stage(s) or may be further processed in a pulping stage, a dissolution stage, or both.

### Amorphous Phase Aqueous Treatment

In some embodiments, cellulose-containing feedstock, cellulose-containing treated solids, or both, are treated, prior to pulping or dissolution, with a high temperature (>320° C.), high pressure (>2.5 Mps) aqueous treatment, in a closed and substantially rigid reaction vessel. This pretreatment stage promotes breakdown of the crystalline structure of cellulose and facilitates modification of cellulosic constituents to an amorphous, non- or less-crystalline structure that is more amenable to pulping, dissolution, or both.

### Treatment with Oxidative/Reducing Agent(s)

In some embodiments, a pretreatment stage involves exposing the cellulose-containing feed material (or cellulose-containing treated solids, or both) to a “bleaching” agent, such as an oxidative or reducing agent, typically in an aqueous solution, at an oxidative/reducing agent concentration and for a residence time sufficient to remove materials such as dyes, finishes, and other contaminants from the cellulosic feedstock. Suitable oxidative agents, reducing agents, or both, include, for example, peroxide compositions (e.g., H₂O₂, Na₂O₂) and perborate (e.g., NaBO₃) compositions. Additional oxidative agents, reducing agents, or both, that may be used in pretreatment stages as described herein include one or more of the following compositions: per carbonate compositions; sodium carbonate; per acetic acid compositions; potassium permanganate; persulfate compositions; ozone; sodium chloride; calcium oxychloride, sodium hypochlorite; calcium hypochlorite; lithium hypochlorite; cloramine; isocynual trichloride; Sulphur dioxide; sodium hydrosulfite; sulphoxylates; acidic sodium sulphite; sodium bosulphite; sodium meta bisulphite; TAED (tetra-acetyl-ethylene-diamine); and sodium hydrosulfite.

In some embodiments, bleaching agent treatment may involve treatment in an aqueous solution of calcium hypochloride (bleach powder) or sodium hypochlorite (NaOCl) in combination with sodium carbonate (soda ash) at a pH in excess of 8 and, in some embodiments, at a pH in excess of 9. Agitation or mixing of the materials in the bleaching agent pretreatment stage may be provided, and treatment with an oxidative, a reducing agent, or both, may take place in a closed reaction vessel.

The bleaching agent solution may be evacuated following a suitable residence time and optional rinsing of the solids with an aqueous solution may be implemented. Aqueous rinsing may take place at ambient temperatures, with the rinse solution removed following a suitable residence time. The bleaching agent may be neutralized, following this treatment, by introduction of a weak acid such as hydrogen peroxide. In some embodiments, multiple bleaching agent treatment cycles may be implemented using different oxidative or reducing reagents to treat the solids at different concentrations, pH conditions, temperature, residence times, the like, or combinations or multiples thereof, as appropriate. Recycling and regeneration of the oxidative or reducing agent(s) may be incorporated in the process, as is known in the art. Introduction of other weak acids may be effective to reduce the pH of the treated, cellulose-containing solids, if desired, following optional rinsing steps.

### Pretreatment with Organic Solvent(s)

In some embodiments, methods disclosed herein provide pretreatment of cellulose-containing feed materials (or cellulose-containing treated solids, or both) by exposure to aqueous media containing one or more organic solvents. Suitable organic solvents may be selected from the group consisting of: acetic acid; acetone; acetonitrile; benzene; 1-butanol; 2-butanol; 2-butanone; t-butyl alcohol; carbon tetrachloride; chlorobenzene; chloroform; cyclohexane, 1,2-di chloroethane; diethylene glycol; di ethyl ether; diglyme (diethylene glycol dimethyl ether); 1,2-dimethoxy-ethane (glyme, DME); dimethyl formamide (DMF); dimethyl sulfoxide (DMSO); 1,4-dioxane; ethanol, ethyl acetate; ethylene glycol; glycerin; heptane; hexamethylphosphoramide (HMPA); hexamethylphosphorous tramide (HMPT); hexane; methanol; methyl t-butyl ether (MTBE); methylene chloride; nitromethane; pentane; 1-propanol; 2-propanol; pyridine; tetrahydrofuran (THF); toluene; triethyl amine; a-xylene; and m-xylene. The aqueous media containing organic solvent(s) is generally maintained at a basic pH, generally at a pH in excess of 9, and often at a pH of 10 or above. Treatment with organic solvents may be achieved using high temperature or cooler aqueous media.

### Enzymatic Treatment

In some embodiments, methods disclosed herein may optionally employ enzymatic treatment to shorten cellulose molecules, increase cellulose solubility, reduce reaction times, or both, in subsequent treatment stages. Suitable enzymes may include endogluconases (e.g., Cel 5A, Cel 7B, Cel 12A, Cel 45, Cel 61A); Cellobiohydrolases (e.g., Cel 6A, Cel 7A); LPMO/GH6 1; cellulases; and the like. In general, temperatures of from about 30° to 90° C., pH between about 4 to about 9 and dwell times of from about 20 min to 48 hours may be suitable for enzymatic treatment.

Enzymatic treatment(s) involving xylanases, alkaline pectinases, lipases, esterases, the like, or combinations or multiples thereof may also be used for feedstock pretreatment prior to pulping. In yet additional embodiments, feedstock may be treated using enzymatic cultures containing biological organisms (fungi, bacteria, etc.) that secrete cellulolytic enzymes (e.g., cellulases). Enzyme cultures such as Trichoderma Reesei, Trichoderma viride, Penicillium janthinellum, Halorhabdusutahensis, A Niger, Humicola, and mixtures of such enzyme-producing cultures, are suitable. Mechanical treatments such as pulverization, emulsification treatment(s), or both, may be implemented following enzymatic treatment.

### Treatment with Swelling Agents

For some applications (for example, those in which natural or light-colored or undyed regenerated fiber is desired as an end-product), optional treatment using a swelling agent, such as an ionic liquid, is employed prior to pulping to enhance the absorption of and penetration of the pulping agent. Treatment with a swelling agent (e.g. an ionic liquid) may be preceded by or implemented in combination with one or more other pretreatment stage(s). Ionic liquids may comprise hydroxides, such as Ca, Mg, Na, K, Li hydroxides, the like, or combinations or multiples thereof. Swelling agents suitable for use as reagents in a pretreatment stage may alternatively or additionally comprise one or more of the following reagents: [AMIM]Cl 1-Allyl-3-methylimidazolium chloride; [BzPy]Cl Benzylpyridinium chloride; [BMIM]Ace 1-Butyl-3-methylimidazolium acesulphamate; [BMIM]DBP 1-Butyl-3-methylimidazolium dibutylphosphate; [BMIM]Cl 1-Butyl-3-methylimidazolium chloride; [BMIM]PF6 1-Butyl-3-methylimidazolium hexafluorophosphate; [BMIM]BF4 1-Butyl-3-methylimidazolium tetrafluoroborate; [BMPy]Cl 1-Butyl-3-methylpyridinium chloride; [DBNH]AcO 1,8-Diazabicyclo[5.4.0]undec-7-enium acetate; [DBNH]EtCOO 1,8-Diazabicyclo[5.4.0]undec-7-enium propionate; [DMIM]DEP 1,3-Dimethylimidazolium diethylphosphate; [DMIM]DMP 1,3-Dimethylimidazolium dimethylphosphate; [EMBy]DEP 1-Ethyl-3-methylbutylpyridinium diethylphosphate; [EMIM]AcO 1-Ethyl-3-methylimidazolium acetate; [EMIM]Br 1-Ethyl-3-methylimidazolium bromide; [EMIM]DBP 1-Ethyl-3-methylimidazolium dibutylphosphate; [EMIM]DEP 1-Ethyl-3-methylimidazolium diethylphosphate; [EMIM]DMP 1-Ethyl-3-methylimidazolium dimethylphosphate; [EMIM]MeS04 1-Ethyl-3-methylimidazolium methanesulphonate; [HPy]Cl 1-Hexylpyridinium chloride; [E(OH)MIM]AcO 1-Hydroxyethyl-3-methylimidazolium acetate; [DBNMe]DMP 1-Methyl-1,8-diazabicyclo[5 0.4. O]undec-7-enium dimethylphosphate; [P4444]0H Tetrabutylphosphonium hydroxide; [TMGH]AcO 1,1,3,3-Tetramethylguanidinium acetate; [TMGH]n-PrCOO 1,1,3,3-Tetramethylguanidinium butyrate; [TMGH]COO 1,1,3,3-Tetramethylguanidinium formiate; [TMGH]EtCOO 1,1,3,3-Tetramethylguanidinium propionate; [P8881]Ac0 Trioctylmethylphosphonium acetate; and HEMA Tris-(2-hydroxyethyl)methylammonium methylsulphate.

In one exemplary embodiment, cellulose-containing feed materials (or cellulose-containing treated solids, or both) may be treated with an ionic solution such as an aqueous solution comprising Ca, Mg, Na, K, Li hydroxides, the like, or combinations or multiples thereof, followed by exposure to a sodium hydrosulfite (Na₂S₂O₄) reducing agent, a bleaching agent such as peroxide, perborate, persulfate, and sodium or calcium hypochlorite, or both. Small amounts of Bromium (Br) may be used as a catalyst during this treatment. This treatment is generally carried out at a pH in excess of 9, and often at a pH of 10 or 10.5 or above. Treatment with swelling agents such as ionic liquids may be achieved using high temperature or cooler aqueous wash media. In some embodiments, treatment with a swelling agent (e.g., an ionic liquid) is conducted at temperatures of 0° C. or lower, provided the aqueous solution or slurry is prevented from freezing, and provided the viscosity of the solution is maintained at an acceptable level. In some embodiments, and particularly when ionic liquids having an acetate group are used, the treatment may be carried out at an acidic pH, typically at a pH less than 6, and in some embodiments at a pH less than 5. In some embodiments, the proportion of cellulose-containing feed materials (or cellulose-containing treated solids, or both) in the ionic solution is from about 2% to about 40%; in some embodiments, the proportion of cellulose-containing feed materials (or cellulose-containing treated solids, or both) in the ionic solution is from about 5% to about 25%.

It will be appreciated that numerous (optional) pretreatment processes are described herein and are illustrated in FIGS. 1 and 2. Pretreatment of cellulose-containing feedstock material, as described, may implement any of these pretreatment processes, singly or in combination with one or more other pretreatment processes. In some embodiments, carrying out elevated temperature aqueous pretreatment in a closed vessel is preferred, alone or in combination with other pretreatment stages, prior to pulping and dissolution of the cellulose polymers. In some embodiments, carrying out elevated temperature aqueous pretreatment with the use of ozone enrichment, oxidative agents, surfactants, the like, or combinations or multiples thereof is preferred, alone or in combination with other pretreatment stages, prior to pulping. In some embodiments, treatment in ionic solution followed by exposure to a reducing agent, a bleaching agent, or both, is preferred, preferably in combination with a washing step. In some embodiments, pretreatment involves elevated temperature aqueous pretreatment, followed by ionic pretreatment, followed by enzymatic pretreatment. In some embodiments, one or more of the pretreatment stages, or all pretreatment stages, are carried out a pH of at least about 9. In some embodiments, one or more of the pretreatment stages, of all of the pretreatment stages, are carried out at a pH of at least about 10.

Pretreatment preferably takes place in a closed vessel and, in batch treatment schemes, one or more pretreatment reagents may be introduced to and withdrawn from a closed vessel during various pretreatment stages, with or without intermediate rinsing or washing stages. In some embodiments, the vessel may be provided in the form of a rotating cylinder with a pressurized hull (housing) capable of withstanding pressures in the range of from 1000-5000 kPa, having inlet and outlet ports, pH and rpm control features, and having liquid agitation or circulation features. The inner reaction vessel surfaces may comprise anticorrosive metal(s) capable of withstanding concentrated acidic and alkali solutions. In some processes, both pretreatment and pulping may take place in the same vessel.

Specific pretreatment combinations are described below with reference to the schematic flow diagrams shown in FIGS. 3-7. Each of these flow diagrams describes different feedstock pretreatment combinations, followed by molecular isolation and separation of cellulose polymers in a pulping or dissolution stage. Cellulose polymers may be separated from the pulping solution, such as by filtration, and regenerated cellulosic fibers may be extruded, such as in connection with a precipitation bath (e.g., an acid bath). Extruded fibers may be designed and parameters changed, depending on the type, character and physical attributes of the cellulosic fibers desired. Drying and winding produces regenerated cellulosic fibers.

FIG. 3 illustrates treatment of cellulose-containing materials (with optional sorting and removal of non-cellulosic components) using a high temperature aqueous wash or supercritical carbon dioxide pretreatment stage in combination with ozone enrichment, oxidative agent(s), surfactant(s), the like, or combinations or multiples thereof. Following evacuation of the hot aqueous or supercritical CO2 media used for washing, and optional rinsing of the cellulosic solids, the cellulosic solids may optionally be treated with swelling agents (as described above), with organic solvents (again, as described above), or both. These treatment stages may be done at elevated temperatures or in cooler aqueous media.

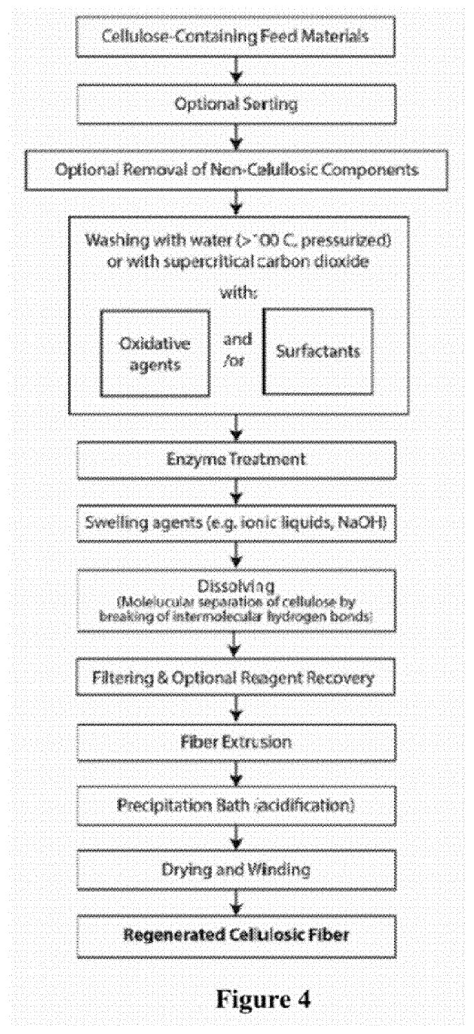

FIG. 4 illustrates treatment of cellulose-containing materials (with optional sorting and removal of non-cellulosic components) using a high temperature aqueous wash or supercritical carbon dioxide pretreatment stage in combination with oxidative agent(s), surfactant(s), or both. Following evacuation of the hot aqueous or supercritical CO2 media used for the washing stage, and following optional rinsing of the cellulosic solids, the cellulosic solids may optionally undergo enzymatic treatment as described above. The cellulosic solids may subsequently be exposed to swelling agents such as ionic liquids (e.g., NaOH) prior to a pulping or dissolution stage.

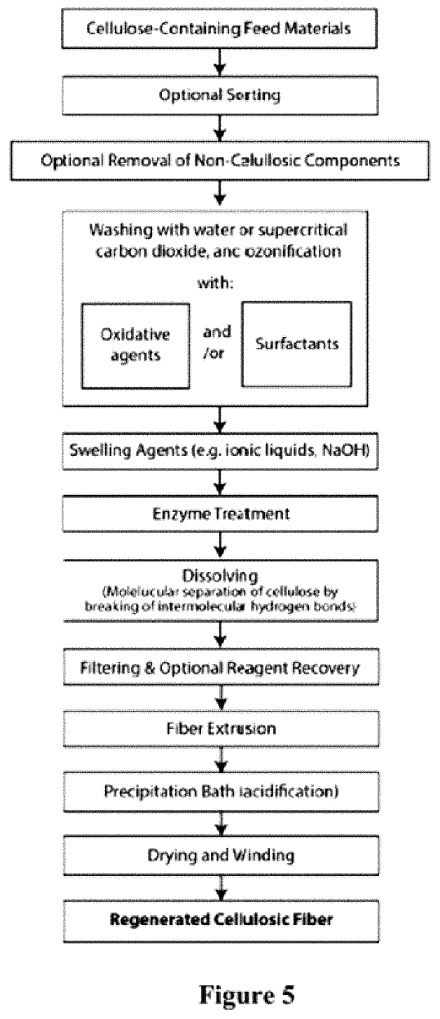

FIG. 5 illustrates treatment of cellulose-containing materials (with optional sorting and removal of non-cellulosic components) using a high temperature aqueous wash or supercritical carbon dioxide pretreatment stage in combination with oxidative agent(s), surfactant(s), or both. Following evacuation of the hot aqueous or supercritical CO₂ media used for the washing stage, and following optional rinsing of the cellulosic solids, the cellulosic solids may optionally be exposed to swelling agents such as ionic liquids (e.g., NaOH), followed by enzymatic treatment as described above prior to a pulping or dissolution stage.

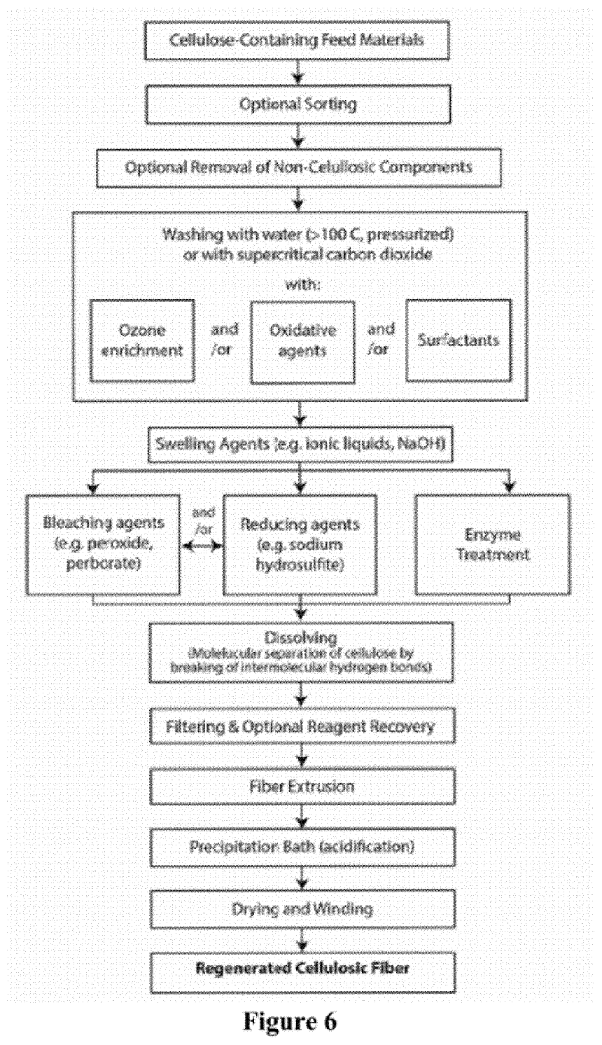

FIG. 6 illustrates treatment of cellulose-containing materials (with optional sorting and removal of non-cellulosic components) using a high temperature aqueous wash or supercritical carbon dioxide pretreatment stage in combination with optional ozone enrichment, oxidative agent(s), surfactant(s), the like, or combinations or multiples thereof. Following evacuation of the hot aqueous or supercritical CO₂ media used for the washing stage, and following optional rinsing of the cellulosic solids, the cellulosic solids may optionally be exposed to swelling agents such as ionic liquids (e.g., NaOH), followed by exposure to bleaching agents, reducing agents, an enzyme treatment, the like, or combinations or multiples thereof, all as described above, prior to a pulping or dissolution stage.

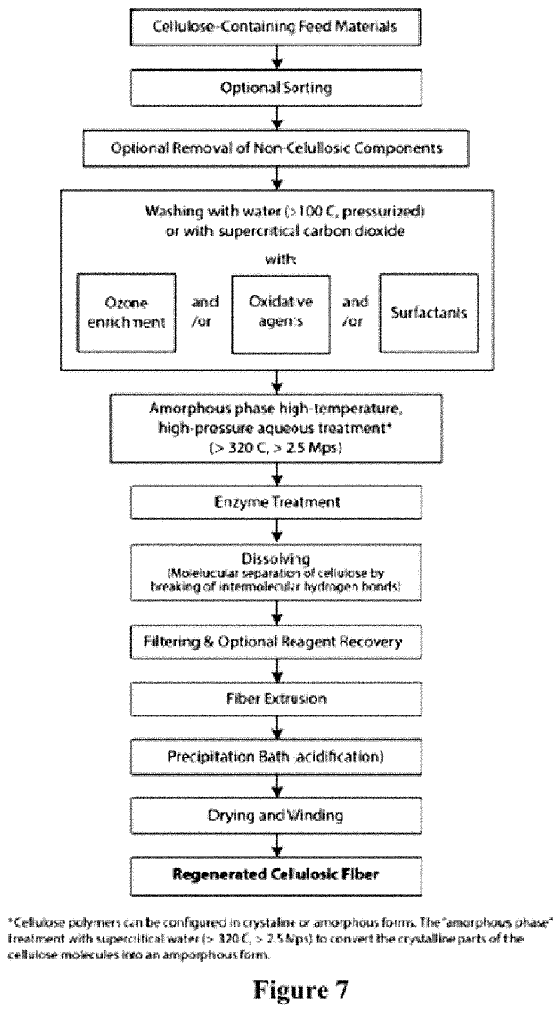

FIG. 7 illustrates treatment of cellulose-containing materials (with optional sorting and removal of non-cellulosic components) using a high temperature aqueous wash or supercritical carbon dioxide pretreatment stage in combination with optional ozone enrichment, oxidative agent(s), surfactant(s), the like, or combinations or multiples thereof. Following evacuation of the hot aqueous or supercritical CO2 media used for the washing stage, and following optional rinsing of the cellulosic solids, the cellulosic solids may optionally undergo a high-temperature, high-pressure aqueous treatment stage, as described above, to promote destruction of the cellulosic crystalline structure and favor conversion of cellulosic polymers to an amorphous phase. The cellulosic solids may be exposed to enzyme treatment, as described above, prior to a pulping or dissolution stage.

Treated cellulose-containing solids are subjected to a pulping or dissolving stage, in which the cellulose-containing solids are treated in a pulping reagent to promote molecular separation of cellulose polymers and destruction of intermolecular hydrogen bonds and other non-covalent bonds, converting cellulose-containing solids to their constituent cellulose polymers. In some embodiments, the number of intermolecular hydrogen bonds present in the cellulose polymers is reduced by at least 20% in the fiber pulping stage; in some embodiments the number of intermolecular hydrogen bonds present in the cellulose polymers is reduced by at least 50% in the fiber pulping stage; in yet other embodiments, the number of intermolecular hydrogen bonds present in the cellulose polymers is reduced by at least 70% in the fiber pulping stage. The viscosity of pulped cellulose, following the pulping treatment, is generally from about from 0.2 to as high as 900 cP, often from about 0.5 to about 50 cP.

A variety of pulping techniques and pulping chemistries are available, and one or more of the pretreatment stages described above may be used with a variety of known pulping reagents, including those described in PCT Int'l Patent Publication WO 2013/124265 A1, the disclosure of which is incorporated herein by reference in its entirety.

In some embodiments, copper-containing reagents are preferred for use as pulping reagents. In one embodiment, for example, Schwiezer's Reagent (the chemical complex tetraaminecopper (II) hydroxide —[Cu(NH₃)₄(H₂O)₂]) or tetraamminediaquacopper dihydroxide, [Cu(NH₃)₄(H₂O)₂](OH)₂ is a preferred pulping agent to isolate and promote molecular separation of cellulose polymers. Schweizer's reagent may be prepared by precipitating copper(II) hydroxide from an aqueous solution of copper sulfate using sodium hydroxide or ammonia, then dissolving the precipitate in a solution of ammonia. In some embodiments, a combination of caustic soda, ammonium and cupramonium sulfate may be formulated to provide Schwiezer's Reagent.

Solutions comprising copper(II) hydroxide and ammonia may be introduced and used in the pulping stage to form Schweizer's Reagent according to the following reaction: Cu(OH)₂+4NH₃+2H₂O→[Cu(NH₃)₄(H₂O)₂]²⁺+2OH. In this scheme, the copper hydroxide reagent may be manufactured from recycled copper recovered, for example, from electronics and computer component waste materials. Copper hydroxide is readily made from metallic copper by the electrolysis of water using copper anodes. Ammonia may be manufactured by an innovative use of the Haber-Bosch process (3H₂+N₂→2NH₃) capturing hydrogen from organic wastes and combining it with atmospheric nitrogen. This method may produce ammonia at low cost and eliminate greenhouse gas emissions from organic waste feedstock. Using these reagent resources and methods for generating Schweizer's Reagent, all or substantially all of the materials used in the fiber pulping process described herein (including the cellulose-containing feedstock) may be sourced as waste products, resulting in minimal or no use of nonrenewable resources.

Other cellulose-dissolving agents may also be used in the pulping stage, such as iron-containing and zinc-containing reagents. In one embodiment, iron tartrate complex solvents (e.g., FeTNa) may be used as pulping reagents. FeTNa solutions may be prepared according to the procedure published by Seger et al. (B. Seger, et al., Carbohydrate Polymers 31 (1996) 105.) FeTNa solutions are prepared and stored while protecting them from light. The FeTNa complex may be prepared, for example, by dissolving sodium tartrate dehydrate (Alfa Assar, Cat. #16187) in deionized water, stirring and optionally heating. When the sodium tartrate dissolved, iron nitrate nonahydrate (Alfa Aesar, Cat. #12226) is added to the solution with continuous stirring. The solution is then cooled to 10-15° C. to prevent precipitation of the iron complex. 12 M sodium hydroxide solution is slowly added to the tartrate-ferric acid under controlled conditions to prevent the temperature from rising over 20° C. The solution color shifts from reddish-brown to yellowish-green, signifying the formation of the FeTNa complex. After this transition, the remaining sodium hydroxide may be added without regard to temperature. Sodium tartrate is added at the end to ensure long-term stability of the solution.

Pulping conditions using an FeTNa pulping reagent are generally basic and may be carried out at pH above 12, or above 13, or at a pH of about 14 in a closed reaction vessel. Reactions carried out using FeTNa pulping reagent at a pH of 14 in a closed reaction vessel kept at 4° C. successfully dissolved cotton feedstock. Carrying out the pulping reaction in an inert atmosphere is generally preferred, and circulating an inert gas such as argon through the pulping solution prior to and during addition of pretreated feedstock may improve dissolution rates, yields, or both.

In another embodiment, zinc-containing reagents such as Zincoxen solutions may be used as pulping reagents. The active ingredients of the zincoxen solution are zinc oxide (ZnO) and EDA. Zincoxen solutions may be prepared according to the procedures published by Shenouda and Happey (S. G. Shenouda and F. Happey, European Polymer Journal 12 (1975) 289) or Saxena, et al. (V. P Saxena, et al., Journal of Applied Polymer Science 7 (1963) 181). Ethylenediamene-water solutions are chilled to 0° C. followed by stirring in zinc oxide powder. Continuous stirring for 72 hours while maintaining the temperature at 0° C. produces a suitable Zincoxen solution. Pulping conditions using a Zincoxen pulping reagent are generally basic and may be carried out at pH above 12, or above 13, or at a pH of about 14 in a closed reaction vessel.

In general, residence times of up to 4-48 hours in the pulping stage are suitable to dissolve and promote molecular separation of cellulose molecules present in the treated cellulose-containing feedstock. In some embodiments, the pulping stage takes place in a closed chamber and an inert gas, such as nitrogen or argon, is introduced in the airspace to inhibit or prevent oxidation of pulping solution constituents. Oxygen-containing gases may be substantially evacuated from the pulping stage. In some embodiments, agitation of the pulping mixture, mixing of the pulping mixture, or both, may be provided; in some embodiments, an inert gas, such as nitrogen or argon, may be bubbled through the pulping mixture prior to pulping, during pulping, or both.

The cellulose molecules are substantially isolated and may be fully or partially dissolved to form substantially linear cellulose chains in the pulping stage, depending on the reagent used and the residence time. The pulping solution is filtered, following a suitable residence time, to remove non-cellulosic constituents with the solution and isolate substantially purified cellulose polymers, which are typically suspended in a viscous media. Filtration may involve multiple stages, including an optional centrifugation stage and one or more size exclusion filtration stages. A final filtration stage using pore sizes of 1 micron or less may be employed. The isolated, substantially purified cellulose polymers may be used in a wide range of downstream applications (See, e.g., FIG. 1) and, in particular applications, are used in fiber production applications to produce regenerated cellulosic fiber (See, e.g., FIGS. 2-7).

The conditions of the pulping stage and the composition of the fabric feedstock are important factors in determining whether a cotton-like fiber or rayon is produced form the pulped cellulosic materials in subsequent processing. Full dissolution of the cellulosic fibers is generally desirable for the production of rayon-like fibers, cotton-like fibers and other regenerated cellulosic fibers. Suitable solvent concentrations, reagent to feedstock ratios, residence times, and the like, may be determined using routine experimentation. While Schwiezer's Reagent and the other iron- and zinc-containing pulping reagents described above are suitable pulping solvents for many applications, it will be appreciated that other pulping reagents may be available, or may be developed, and would be suitable for use in the processes described herein.

In some embodiments, energy is introduced to the pulped solution during a desired degree of pulping, following a desired degree of pulping, or both. When the pulping stage is carried out in a closed reaction chamber, mechanical energy, electrical energy, such as radio frequency energy, or both, may be introduced during or following pulping to enhance separation of different components and promote sedimentation of heavier components. If the cellulose-containing feedstock was not pretreated to remove non-cellulosic components, suitable filtration, screening exclusion treatment, size exclusion treatment, the like, or combinations or multiples thereof, may be performed, during or following pulping, to remove non-organic materials (e.g., buttons, fasteners, zippers, etc.), as well as impurities and non-cellulosic materials from the fiber pulp solution. Suitable f filtration, screening exclusion treatment, size exclusion treatment, the like, or combinations or multiples thereof, will depend on the types and level of contaminants remaining in the fiber pulp solution. Filtration may involve scraping the top of the reaction vessel, the bottom of the reaction vessel, or both, to remove floating or sinking debris; simple size exclusion filtration; gravitation separation or centrifugation to separate solids from the dissolved cellulosic materials; the like, or combinations or multiples thereof. In some embodiments, a cascade of progressively smaller pore size filtration stages may follow preliminary separation by gravitation or centrifugation.

Separated by-products may be isolated and purified (if appropriate) for re-sale or distribution to secondary markets.

In some embodiments, the pulping solution may be optionally treated with glycerin or glycerol or another agent to impart softness to the texture of the fiber.

### Fiber Extrusion

After pulping, isolated cellulose molecules may be extruded to form regenerated fibers and textile materials. The isolated cellulose molecules are generally filtered or otherwise separated, and may be acidified and processed in a wet extrusion stage to precipitate cellulose fibers and produce cotton fibers, rayon fibers, or a mixture of cotton and rayon fibers. Various acids may be used in this precipitation stage, such as sulfuric, citric or lactic acids. In one embodiment, a sulfuric acid bath is used in combination with a wet extrusion process, wherein the viscous cellulose polymer solution is pumped through a spinneret, and the cellulose is precipitated to form fibers as it contacts the acid bath. The extrusion process, system, or both, may be modified and adjusted to produce fibers having different lengths, diameters, cross-sectional configurations, durability, softness, moisture wicking properties, and the like. In this process, the newly formed fibers are stretched, blown, or both, to produce desired configurations, washed, dried, and cut to the desired length.

Closed vat, continuous fiber extrusion techniques may be used. Closed vat systems allow recovery, recycling, or both, of any produced gases and by-products. Using fiber extrusion techniques is highly advantageous when applied to the regeneration of cellulosic materials to produce cotton fibers, rayon fibers, or both, since it allows a high degree of custom design and engineering of cellulosic fibers to achieve targeted comfort and performance characteristics (e.g., fiber length, diameter, cross-sectional shape, durability, softness, moisture wicking, etc.). Naturally grown fibers cannot be produced in desired or specified fiber lengths, diameters, cross-sectional profiles, or the like and cellulosic fibers regenerated using this process may therefore have different, and superior, properties compared to the natural fibers present in the initial recycled fabric feedstock.

In some embodiments, fiber extrusion may produce fibers having a denier of from about 0.1 to 70 or more denier. In some embodiments, fiber extrusion may involve extruding multifilaments having from about 20 to 300 single monofilaments, each having a denier of from about 0.1 to about 2. Extruding fine denier filaments produces woven fabric that feels softer to the touch and is desired in many embodiments. In some embodiments, fiber extrusion may additionally involve adding a false twist to the extruded filaments and texturizing them to resemble spun yarn. These treatments may obviate the necessity of using opening and spinning processes to produce yarn from the extruded fibers. Further handling of the fibers may involve cutting the continuous fiber to specific uniform lengths (stapling), missing, opening, carding, drawing, rowing, spinning, etc.

Following fiber extrusion and spinning to form yarns, fabrics, textiles and the like, waterless dyeing techniques may be used to further reduce the environmental impact of the overall process. Waterless dyeing technologies are available and typically use supercritical carbon dioxide as a solvent and carrier for dyestuff. In some embodiments, color treatment of regenerated fibers may involve determining the absorbency of the regenerated fiber and determining the color properties of fibers using spectrophotometric techniques. Color signatures and dye formulations may then be customized according to the specific properties of regenerated fibers to eliminate differences in coloration that may result from different batch qualities. In some embodiments, regenerated fibers or yarns may be surface treated (e.g., using a bleaching composition) and then dyed or overprinted using, for example, reactive, direct, pigment, sulfur, vat dye types and prints, the like, or combinations or multiples thereof. In some applications, all fiber regeneration process steps, from garment reclamation to fiber extrusion, may be located at a common geographic site (or at nearby sites). For some purposes, it may be desirable to locate different stages of the process at different physical locations. It may be desirable, in some applications, for example, to locate garment reclamation sites in populous areas, while locating other processing facilities and, in particular, the wet extrusion facility, in locations proximate textile processing facilities—e.g. near textile mills, garment manufacturing facilities, the like, or combinations or multiples thereof. In some applications, garment reclamation and initial processing may take place at one location and cellulosic pulp may then be shipped or transported to a different location for wet extrusion and other downstream processing (e.g., dying, garment manufacturing, etc.).

Regenerated cellulosic fibers (e.g., cotton, rayon, or both) produced as described above may be twisted into thread, dyed, bleached, woven into textiles and, ultimately, cut and sewn into garments.

In another aspect, fiber pulping of low grade cotton fibers, harvested naturally or produced from a raw material fabric feedstock as described above, is provided. In this process, low grade natural cotton fibers (e.g., low staple length cotton fibers) may be pulped as described herein, and then acidified and subjected to a wet extrusion process to produce newly formed fibers which may be stretched, blown, or both, to a desired diameter, cross-sectional profile or the like, washed, dried, and cut to a desired length. In this fashion, low grade (natural, recycled, or both) cotton fibers may be regenerated and converted to newly formed, higher value fibers having more desirable properties than those of the original natural cotton fibers, recycled cotton fibers, or both.

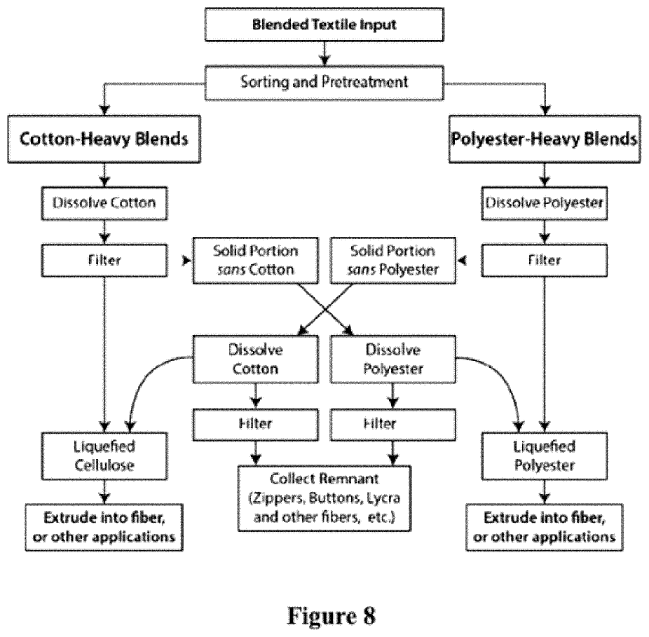

FIG. 8 shows a schematic flow diagram illustrating the processing of a blended textile input according to methods described herein. In this scenario, blended textile input is separated into cotton-heavy and polyester-heavy blends during one or more sorting and pretreatment step(s). The constituent cotton and polyester polymers in each of the separated stages are dissolved and isolated to produce “liquefied” cellulose (from the cotton-heavy feedstock) and “liquefied” polyester from the polyester-heavy feedstock. These isolated cellulosic and polyester materials may be extruded into regenerated fibers, as desired, or used for other downstream applications. The undissolved, non-cellulosic constituents remaining after dissolution of the cotton-heavy blend feedstock may be treated for dissolution of polyester to produce liquefied polyester. Likewise, the undissolved, non-polyester constituents remaining after dissolution of the polyester-heavy blend feedstock may be treated for dissolution of cellulose to produce a liquefied cellulose. Undissolved components such as other fibers, zippers, buttons, and the like, may be collected and re-used or discarded.

Although the process has been described primarily with reference to using cotton garments and feedstock containing cotton materials, it will be appreciated that other types of fabrics may be pulped and regenerated using the same or similar processes to produce regenerated fibers. It will also be appreciated that additional process steps may be employed, as is known in the art, and that equivalent treatment steps may be substituted for those described above.

### Recoverable Elastomers

An elastomer is a natural or synthetic polymer having elastic properties. A recoverable elastomer is an elastomer capable of being retrieved or extracted from feedstock, such as to re-purpose the elastomer for production of one or more articles of manufacture, to permit the non-elastomer component of the feedstock to be recycle or re-used, combinations thereof, or the like, is discussed herein. The one or more articles of manufacture can be, for example, clothing, textiles, garments, upholstery, containers (e.g., bags or baskets), carpet, window shades, towels, coverings (e.g., for beds, tables, etc.), or the like. The recoverable elastomer is used in one or more articles of manufacture. The elastomer can be recoverable from feedstock composed of the recoverable elastomer by undergoing processing. The recoverable elastomer, such as after processing, can be re-polymerized and used in one or more subsequent articles of manufacture.

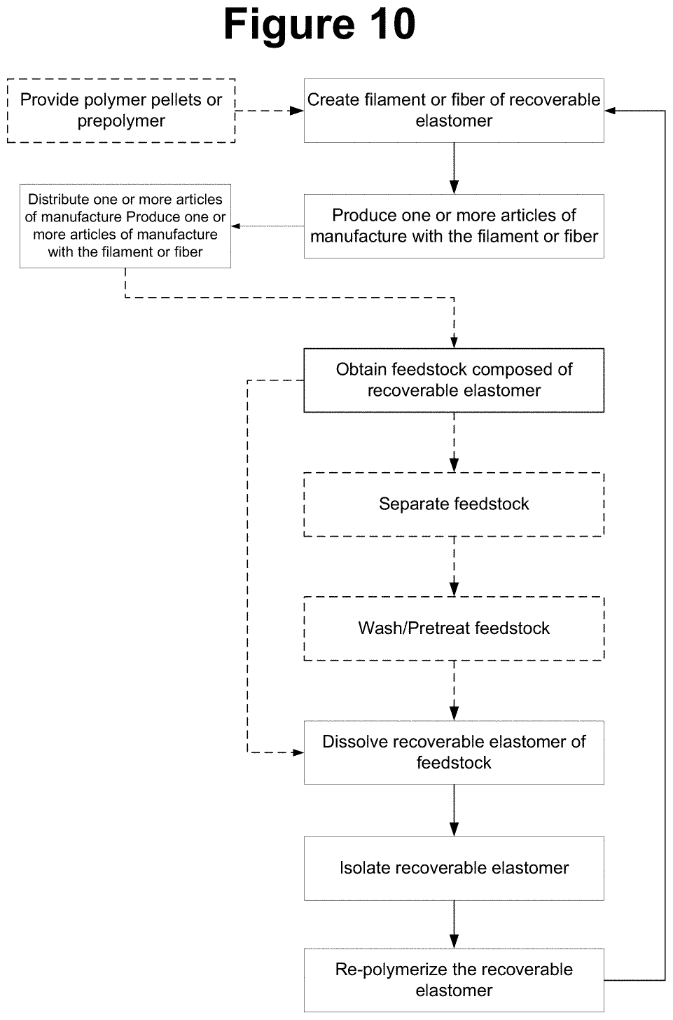

FIG. 10 shows a flowchart for developing and retrieving a recoverable elastomer to produce a first article of manufacture and then a second article of manufacture.

A filament of the recoverable elastomer is produced, such as by melt extrusion, reaction spinning, solution dry spinning, solution wet spinning, or combinations thereof. In one example (as shown as an optional step), the raw material used to create the filament is obtained from polymer pellets, prepolymers, or combinations thereof. The polymer or prepolymer can include, without limitation, polyamide, polyurethane, polyester, polyether, polyurea, diisocyanate, polymerized acrylate ester, polyisoprene, a macroglycol, combinations thereof (such as copolymers), or the like. In another example (such as after one or more articles of manufacture is produced with the recoverable elastomer), as further discussed below, the raw material used to create the filament is obtained from the recoverable elastomer having been re-polymerized after being recovered from feedstock (e.g., clothing, textiles, garments, upholstery, containers (e.g., bags or baskets), carpet, window shades, towels, coverings (e.g., for beds, tables, etc.), or the like) which includes recoverable elastomers. In yet another example, a first recoverable elastomer filament is produced from a raw material of polymer pellets, prepolymer, or combinations thereof; and a second recoverable elastomer filament is produced from feedstock including a textile, a garment, or a combination thereof made from the first recoverable elastomer filament.

The recoverable elastomer is unmodified (e.g., no functionalization, changes to surface chemistry, or the like), not cross-linked, and does not include any stabilizers.

An article of manufacture (e.g., clothing, textiles, garments, upholstery, containers (e.g., bags or baskets), carpet, window shades, towels, coverings (e.g., for beds, tables, etc.), or the like) is the produced using the recoverable elastomer filament. The article of manufacture can be produced with any appropriate method including, without limitation, knitting or weaving. When the recoverable elastomer filament is incorporated into an article of manufacture, the article of manufacture can be sold commercially, used to produce one or more other articles of manufacture, or both. For example, when used in clothing or garments, the recoverable elastomer provides for functional fitting—in other words, the clothing or garment can stretch, be form-fitting, both, or the like.

Feedstock produced from or composed of recoverable elastomer filament is obtained. The feedstock can be post-consumer waste garments, scrap fabric, unworn garments, discarded articles of manufacture or portions thereof, combinations thereof, or the like.

The feedstock can be physically separated into at least two groups based on one or more factors, including the percentage of recoverable elastomer within the individual pieces of feedstock forming each group, the composition of the pieces of feedstock, combinations thereof, or the like. For example, a first group includes one or more pieces of feedstock (e.g., a t-shirt, jeans, and gloves) composed of 1-5% recoverable elastomer, a second group includes one or more pieces of feedstock (e.g., yoga pants and socks) composed of 6-10% recoverable elastomer, and so on. For another example, a first group includes one or more pieces of feedstock composed of cotton and a recoverable elastomer, a second group includes one or more pieces of feedstock composed of wool and recoverable elastomer, a third group includes one or more pieces of feedstock composed of silk and recoverable elastomer, and so on. As yet another example, a first group includes one or more pieces of feedstock having a first percentage of recoverable elastomer and composed of a first set of fabrics, a second group includes one or more pieces of feedstock having the first percentage of recoverable elastomer and composed of a second set of fabrics, a third group includes one or more pieces of feedstock having a second percentage of recoverable elastomer and composed of the second set of fabrics, and so on. The percentages and groups discussed above are examples and are not intended to be so limited.

The feedstock can be washed, pretreated, or both to remove contaminants (e.g., dirt, grease, food, or the like), dyes, chemical finishes, combinations thereof, or the like. When the feedstock is physically separated, the washing or pretreating steps can be performed before or after separation. The washing or pretreating steps can include, without limitation, high temperature aqueous washing; supercritical CO₂ washing; amorphous phase aqueous treatment; treatment with one or more oxidative agents, one or more reducing agents, one or more organic solvents, one or more enzymes, one or more swelling agents, combinations thereof, or the like.

Feedstock can be mechanically treated to provide smaller sized, or more uniformly sized, feedstock. The feedstock can be sized, when it is desirous to do so, such as by shredding, to provide a sized feedstock having a fragmented, high surface area. Feedstock sizing can also be accomplished using mechanical cutting, shredding, or other mechanical size reduction techniques. Processing to remove non-fabric components, such as buttons, zippers, fasteners, and the like can occur, when it is desirous to do so.

The feedstock is then processed to obtain the recoverable elastomer. Processing includes dissolving one or more components of the feedstock, isolating one or more components of the feedstock, or both. The processing can be performed at ambient or room temperature (10-35° C.). After the dissolving step, the isolating step, or both, the chemical, reagent, solution, solvent, combinations thereof, or the like can be denatured. In one example, processing does not damage other components of the feedstock, including cotton, wool, polymers, composites, or the like.

In one example, the recoverable elastomer component is dissolved first and then isolated from the remaining feedstock. In another example, the non-recoverable elastomer component is dissolved first, then isolated from the remaining feedstock, such that the recoverable elastomer is remaining. In yet another example, one or the non-recoverable elastomer components is dissolved first and isolated from the remaining feedstock, then the recoverable elastomer is dissolved and isolated.

The dissolving step can be performed with a chemical, reagent, solution, solvent, combinations thereof, or the like. The formula (such as concentration, volume, or the like) for the chemical, reagent, solution, solvent, combinations thereof, or the like used in the processing step, though more specifically the dissolving sub-step, can be determined based on one or more factors of the recoverable elastomer, including, for example, molecular weight of the recoverable elastomer, total mass of the recoverable elastomer within the portion of the feedstock being processed, the composition percentage of the recoverable elastomer within the individual pieces of feedstock, combinations thereof, or the like. In one example, the processing is performed with a non-toxic chemical, reagent, solution, solvent, combinations thereof, or the like. For example, the chemical is dimethyl sulfoxide (DMSO) or dimethyl sulfide (DMS).

The isolating step can be performed by any appropriate method of separating the desired feedstock component from the non-desired feedstock component(s). For example, isolating can be filtering, precipitating, combinations thereof, or the like.

After processing, the recoverable elastomer is re-polymerized using any appropriate polymerization method. The re-polymerized recoverable elastomer can then be used to form recoverable elastomer filament to produce one or more subsequent articles of manufacture.

In one example, the one or more steps of the process can be carried out in a continuous, semi-continuous or batch system.

In one example, the one or more steps of the process can be carried out in one or more closed reaction vessel(s), in one or more open reaction vessel(s), or both.

In one example, the chemicals, reagents, solutions, solvents, combinations thereof, or the like can be recovered and re-used or processed for other uses.

Though the recoverable elastomer is disclosed in filament form, the recoverable elastomer can be in staple fiber form.

### Repolymerization

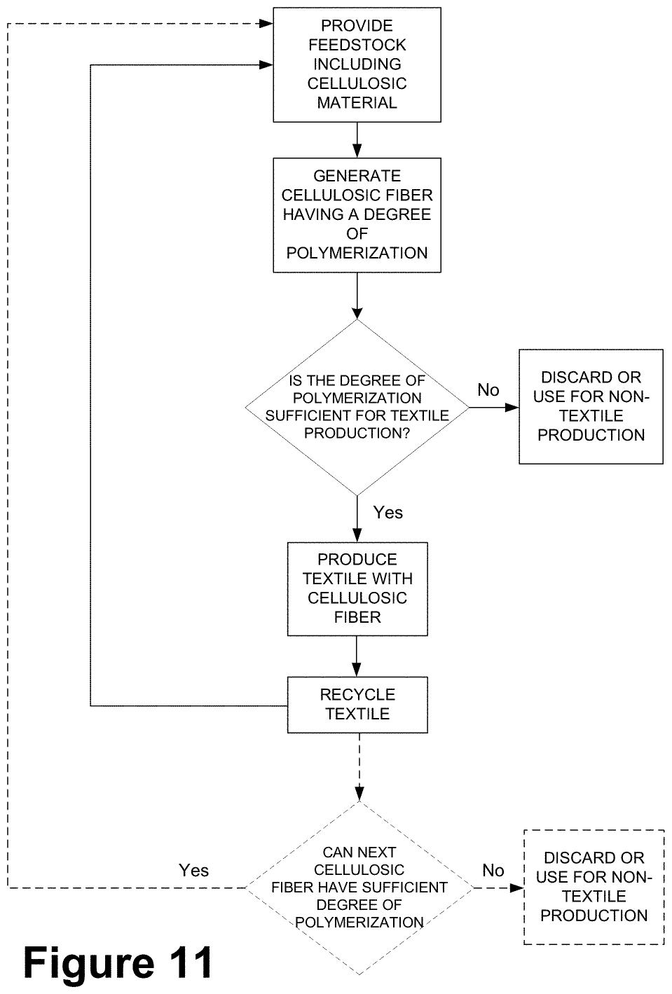

FIG. 11 shows a schematic flow diagram outlining process steps as disclosed herein for performing multiple rounds of cellulosic material regeneration. Cellulosic fibers, such as those to produce a textile, can undergo multiple rounds of regeneration. For example, a first set of cellulosic fibers is produced. A first textile is produced with the first set of cellulosic fibers. A garment or the like is produced with the first textile. The garment is then recycled using one or more processes discussed above to provide regenerated cellulosic fibers. During the regeneration process, cellulosic fibers are isolated from non-cellulosic material, repolymerized, and then extruded to form a second set of cellulosic fibers. The process for producing a textile then repeats with the second cellulosic fibers. Regeneration and production can be repeated any appropriate number of times until the regenerated cellulosic fibers do not have the necessary or appropriate degree of polymerization for textile production.

Degree of polymerization is the number of monomeric units that comprise a macromolecule, a polymer, or an oligomer. Degree of polymerization is equal to the molecular weight of a polymer divided by the molecular weight of the monomer that forms the polymer. For example,

$$Degree of polymerization = \frac{Molecular weight of polymer}{Molecular weight of monomer}$$

Textiles produced or derived from cellulose have varying degrees of polymerization. For example, rayon and Lyocell have degrees of polymerization of 250-450 (average) and cotton has a degree of polymerization of 9,000-15,000 (average).

During regeneration, the degree of polymerization of cellulosic fibers decreases due to degradation. Degradation can occur because one or more chemicals of the regeneration process (e.g., N-methyl morpholine-N-oxide (NMMO), acetone, or the like) reacts with the cellulose, one or more monomers of the cellulose (e.g., beta glucose), or a portion of the cellulose, to form a derivative molecule or chemical, such as cellulose acetate. Therefore, the regenerated cellulosic fiber has a degree of polymerization less than the cellulosic fiber used to produce the textile from which the regenerated cellulosic fiber was regenerated. The degree of polymerization of the cellulose can decrease due to a portion being converted into a cellulose derivative.

The degree of polymerization can decrease by up to 1%, 5%, 10%, 15%, 20%, 25%, 33%, or 50% with each regeneration cycle. For example, a first-generation cellulosic fiber (i.e., a virgin cellulosic fiber) has a degree of polymerization of 3,000. During regeneration, a second-generation cellulosic fiber (i.e., cellulosic fiber regenerated from textile or product made with the virgin cellulosic fiber) has a degree of polymerization of 2,700. Then, during another regeneration, a third-generation cellulosic fiber (i.e., cellulosic fiber regeneration second generation cellulosic fiber) has a degree of polymerization of 2,430.

To start textile production, a virgin cellulosic fiber (i.e., first generation cellulosic fibers) having a degree of polymerization that is large enough to undergo multiple rounds of regeneration (e.g., at least 2, 3, 4, 5, 6, 7, 8, 9, 10, 20, 30, or more) for textile production is provided. Then, as the cellulosic fiber regeneration occurs, the degree of polymerization of the regenerated cellulosic fibers (i.e., second generation cellulosic fibers), while less than the virgin cellulosic fiber, is large enough for textile production. A textile is then produced with the second-generation cellulosic fibers. The textile can then be recycled and the cellulosic fibers can be regenerated again.

In one example, as the cellulosic fiber regeneration occurs again, the degree of polymerization of the second regenerated cellulosic fibers (i.e., third generation cellulosic fibers), while less than the second-generation cellulosic fiber, is large enough for textile production. A textile is then produced with the third-generation cellulosic fibers.

In another example, as the cellulosic fiber regeneration occurs again, the degree of polymerization of the second regenerated cellulosic fibers (i.e., third generation cellulosic fibers) are no longer large enough for textile production. The third-generation cellulosic fibers can then be discarded or used within or for the production of another item or within another industry.

In yet another example, the degree of polymerization for another round of cellulosic fiber regeneration can be determined based on the textiles used for the feedstock. When fibers have a degree of polymerization capable of undergoing another round of regeneration, the textiles can be used for the feedstock and the cellulosic fibers can be regenerated. The process by which regeneration occurs can also be adjusted or selected to provide regenerated cellulosic fibers having sufficient degree of polymerization. However, when the degree of polymerization cannot be sufficient, the textile can be discarded or used for another purpose.

Though repolymerization is discussed in relation to cellulosic fibers, the fibers can be formed from any appropriate material capable of being repolymerized, including, without limitation, elastomers (i.e., elastomeric).

### EXAMPLES

### Example I

A small-scale experiment was conducted to establish feasibility of cellulose pulping and fiber regeneration using shredded cotton garment material as a feedstock. The shredded feedstock material was treated with Schweizer's Reagent to form a dissolved pulping solution, and the pulp solution was acidified by treatment with sulfuric acid. Fibers were regenerated as a result of the acidification.

### Chemical Reactions

1. 2 NaOH(aq)+CuSO₄(aq)→Cu(OH)₂(s)+Na₂SO₄(aq)

2. Cu(OH)₂(aq)→Cu²(aq)+2OH⁻(aq)

3. n Cu²⁺(aq)+(cellulose)ₙ+2n OH⁻→(CuC₆H₈O₅)ₙ+2n H2O

4. Cellulose is actually dissolved in [Cu(NH₃)₄](0 H)₂ solution and then regenerated as cotton or rayon when extruded into sulfuric acid.

5. Note: Filtration of Cu(OH)₂ can be a problem; small amounts of precipitate should be filtered and then combined in one container.

### Process Instructions

1. Dissolve 25.0 g of CuSO₄.5H₂O in 100 mL distilled water. Heat the water to accelerate the dissolving process.

2. Dissolve 8.0 grams NaOH in 200 mL distilled water.

3. Mix the cooled NaOH solution with the copper sulfate solution. Collect the resultant gelatinous precipitate of Cu(OH)₂ by filtration. Wash the precipitate with three 10-mL portions of distilled water. If using 11.0 cm filter paper, several filtrations will be required because of the large amount of precipitate produced.

4. Measure 70 ml concentrated NH₃(aq) into a 250-mL Erlenmeyer flask. Shred 10-15 grams cotton garment. Add the Cu(OH)₂ precipitate carefully along with the filter paper to this flask and stir. This should result in a deep purplish-blue solution of tetraaminecopper (II) hydroxide, referred to as Schweizer's reagent. Stopper the flask and stir periodically for 24 hours or more. Use a magnetic stirrer, if available. One may dip the flask in warm water to speed the process.

5. Take up the contents of the 250-mL Erlenmeyer flask in 10-mL increments in a 10-mL or 50-mL syringe. Squeeze out the contents into a 1000-mL beaker containing 300 mL of 1.6 M sulfuric acid. Be sure that the tip of the syringe or pipet is under the surface of the acid. Crude “thread” forms.

6. The clumps or threads can be washed free of the solution to show the blue-cast white color of the regenerated fibers. Subsequent analysis will demonstrate whether the regenerated fibers have the structure of cotton or rayon.

In alternative schemes, chemical reaction (1), noted above, may be omitted when using copper hydroxide and ammonia reactants to form Schweitzer's reagent as follows: Cu(OH)₂+4NH₃+2H₂O→[Cu(NH₃)₄(H₂O)₂]²⁺+2OH. This alternative chemistry does not require filtration (step 5, above) and produces no by-products that require disposal or removal.

### Example II

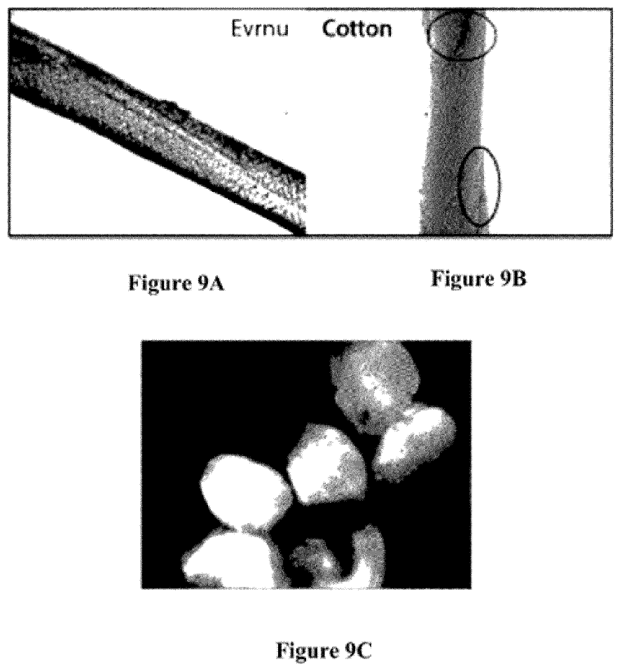

Analyses were conducted to compare regenerated cellulosic fibers, processed as described herein, with virgin cotton fibers. Regenerated cellulosic fiber produced as described above was tested using the ASTM D 2256-02 test method for tensile properties of yams by single-strand method. The regenerated cellulosic fibers exhibited uniform-diameter fiber properties, with the tenacity of cotton and the fineness of silk. Tenacity is a measure of the breaking strength of a fiber divided by the denier. FIG. 9A shows a magnified image of a regenerated cellulosic fiber produced as described above (on the left, labeled Evmu) and FIG. 9B shows a magnified image of a premium long-staple cotton fiber as tested in Harzallah, Benzina & Drean, 2009 (right-side image, labelled “cotton,” reproduced without permission from aforementioned paper). The comparative fiber properties of the regenerated cellulosic fiber produced as described above and the premium long-staple cotton fiber, as reported in the above-mentioned literature reference, are outlined below.

| Fiber properties | EVRNU | Comparison Cotton |
|---|---|---|
| Fiber diameter in micrometers | 20 to 100 | 226.2/80.3 |
| (mean/standard deviation) | (can be | |
| | customized) | |
| Tenacity (gf/tex)-mean | 21.96 | 21.01 |
| Tenacity (gf/tex)-standard | 0.64 | 0.61 |
| deviation | | |
| Elongation %--mean | 2 to 4% | 8.4% |
| | (depends on | |
| | crystallinity) | |
| Sample Size & Comments | Sample size | Cotton #1 sample, |
| | of 3 fibers | tested via the MVI |
| | | method, is selected |
| | | from Harzallah, |
| | | Benzina & Dean 2009. |
| | | Sample size of 25 |
| | | fibers. |

The tenacity tests indicate that regenerated cellulosic fiber produced as described above has similar strength to the tested cotton, for its diameter. Extrusion allows the diameter (and hence absolute strength of individual fibers) to be tightly controlled.

FIG. 9C shows a magnified cross-sectional image of a regenerated cellulosic fiber produced as described above. Extrusion allows for precision control and consistency in fiber cross-section and length. Regenerated cellulosic fibers produced as described herein may be extruded under various conditions and to produce different fiber cross-sectional profiles and lengths. In general, regenerated cellulosic fibers produced herein may be extruded just as other manmade fibers and can be prepared as mono, multifilament or stapled in desired length for ring/OE spinning.

Though certain elements, aspects, components or the like are described in relation to one embodiment or example of a system or method for regenerating cellulosic fibers, those elements, aspects, components or the like can be including with any system or method for regenerating cellulosic fibers, such as when it desirous or advantageous to do so.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

What is claimed is:

1. A method of making a textile, comprising:
producing a second fiber having a second degree of polymerization by processing a first textile feedstock comprising a first fiber having a first degree of polymerization, the second degree of polymerization being less than the first degree of polymerization;
producing a third fiber having a third degree of polymerization by processing a second textile feedstock comprising the second fiber, the third degree of polymerization being less than the second degree of polymerization; and
repeating the producing steps until a final fiber has a degree of polymerization less than a degree of polymerization at which a textile can be produced.

2. The method of claim 1, wherein the first, second, and third fibers are cellulosic.

3. The method of claim 1, wherein the first, second, and third fibers are elastomeric.

4. The method of claim 3, wherein the elastomers are unmodified.

5. The method of claim 1, wherein processing the first textile feedstock comprises:
dissolving the first fiber of the first textile feedstock with a first reagent; and
isolating the dissolved first fiber.

6. The method of claim 5, wherein the first reagent is dimethyl sulfoxide (DMSO) or dimethyl sulfide (DMS).

7. The method of claim 5, wherein isolating the dissolved first fiber includes filtering, precipitating, or filtering and precipitating.

8. The method of claim 5, further comprising producing the first fiber, the first fiber being unmodified.

9. The method of claim 8, wherein the unmodified first fiber does not include any functionalization, any changes to surface chemistry, any stabilizers, is not cross-linked, or combinations thereof.

10. The method of claim 8, further comprising producing an article of manufacture of the first textile feedstock with the first fiber.

11. The method of claim 10, wherein the first fiber is a virgin fiber not having been used in any feedstock or article of manufacture prior to being used to produce the article of manufacture of the first textile feedstock.

12. The method of claim 5, further comprising repolymerizing the dissolved first fiber to form the second fiber, wherein the second fiber is unmodified.

13. The method of claim 12, further comprising producing an article of manufacture of the second textile feedstock with the second fiber.

14. The method of claim 13, wherein processing the second textile feedstock comprises:
dissolving the second fiber of the second textile feedstock with a second reagent; and
isolating the dissolved second fiber.

15. The method of claim 14, wherein isolating the dissolved second fiber includes filtering, precipitating, or filtering and precipitating.

16. The method of claim 14, further comprising repolymerizing the dissolved second fiber to form the third fiber, wherein the third fiber is unmodified.

17. The method of claim 16, further comprising producing an article of manufacture with the third fiber.

18. The method of claim 1, wherein the first textile feedstock is a subset of a first preliminary feedstock or the second textile feedstock is a subset of a second preliminary feedstock, the first and second textile feedstocks being separated from the first and second preliminary feedstocks, respectively, based on a textile feedstock characteristic.

19. The method of claim 18, wherein the textile feedstock characteristic is a percentage of the first fiber or the second fiber within articles of manufacture of the preliminary feedstocks, a material composition of the articles of manufacture of the preliminary feedstocks, or both.

20. The method of claim 1, further comprising washing, pretreating, or washing and pretreating the first textile feedstock, the second textile feedstock, or both first and second textile feedstocks before the respective processing.

21. The method of claim 1, further comprising reducing the size of or providing more uniform sizes of the articles of manufacture of the first or second textile feedstocks before the respective processing.

22. The method of claim 1, further comprising removing non-fabric material from the first or second textile feedstocks before the respective processing.
